(19) United States
(12) Patent Application Publication
(10) Pub. No.: US 2026/0133742 A1
(43) Pub. Date: May 14, 2026

(54) METHOD FOR CONTROLLING CONTENT SHARING, NON-TRANSITORY COMPUTER-READABLE STORAGE MEDIUM, AND TERMINAL

(71) Applicant: GUANGDONG OPPO MOBILE TELECOMMUNICATIONS CORP., LTD., Dongguan (CN)

(72) Inventor: Junwen HU, Dongguan (CN)

(73) Assignee: GUANGDONG OPPO MOBILE TELECOMMUNICATIONS CORP., LTD., Dongguan (CN)

(21) Appl. No.: 19/022,804

(22) Filed: Jan. 15, 2025

Related U.S. Application Data
(63) Continuation of application No. PCT/CN2023/102879, filed on Jun. 27, 2023.

(30) Foreign Application Priority Data
Jul. 18, 2022 (CN) 202210845057.6

(51) Int. Cl. G06F 3/14; G06F 3/04817; G06F 3/0486

(52) U.S. Cl. CPC G06F 3/1454; G06F 3/04817; G06F 3/0486

(57) ABSTRACT

A method for controlling content sharing, an apparatus for controlling content sharing, a non-transitory computer-readable storage medium, and a terminal are provided. The method includes: displaying a terminal interface that includes a plurality of display regions; obtaining first display content displayed in a first display region of the plurality of display regions, in response to a select operation applied on the first display region; and sharing the first display content to a sharing receiving terminal.

### CROSS REFERENCE TO RELATED APPLICATIONS

This application is a continuation of International Patent Application No. PCT/CN2023/102879, filed on Jun. 27, 2023, which claims priority to China Patent Applicant No. 202210845057.6, filed on Jul. 18, 2022, the entire contents of which are incorporated herein by reference.

### TECHNICAL FIELD

Embodiments of the present disclosure relate to the field of intelligent terminal technologies, in particular, to a method for controlling content sharing, a non-transitory computer-readable storage medium, and a terminal.

### BACKGROUND

With a continuous development of internet technologies and mobile terminal technologies, mobile terminals have rapidly become widespread. Today, the mobile terminals have become indispensable and important tools in people's daily lives and work. To meet growing functional demands for mobile terminal applications, the terminal applications are constantly being innovated. A screen-sharing application of the terminal is one of newly introduced terminal applications that has a broad application prospect. Through the screen-sharing application, the terminal may share content displayed on a screen thereof to another terminal, thereby enabling a remote sharing.

### SUMMARY

Some embodiments of the present disclosure provide a method for controlling content sharing, a non-transitory computer-readable storage medium, and a terminal. The method may enhance information security of the terminal during content sharing.

In a first aspect, some embodiments of the present disclosure provide a method for controlling content sharing. The method may include the following operations:
displaying a terminal interface, where the terminal interface includes a plurality of display regions;
obtaining first display content displayed in a first display region of the plurality of display regions, in response to a select operation applied on the first display region; and
sharing the first display content to a share receiving terminal.

In a second aspect, some embodiments of the present disclosure correspondingly provide an apparatus for controlling content sharing. The apparatus may include the following modules.

A display module may be configured to display a terminal interface. The terminal interface includes a plurality of display regions.

An obtaining module may be configured to obtain first display content displayed in a first display region of the plurality of display regions, in response to a select operation applied on the first display region.

A sharing module may be configured to share the first display content to a share receiving terminal.

In a third aspect, some embodiments of the present disclosure provide a non-transitory computer-readable storage medium. The non-transitory computer-readable storage medium may store a computer program which, when executed by a processor of an electronic device, causes the processor to perform an operation in any method for controlling content sharing provided by some embodiments of the present disclosure.

In a fourth aspect, some embodiments of the present disclosure provide a terminal. The terminal may include a processor and a memory. The memory may store a computer program which, when executed by the processor, causes the processor to perform an operation in any method for controlling content sharing provided by some embodiments of the present disclosure.

### BRIEF DESCRIPTION OF THE DRAWINGS

To illustrate the technical solutions in some embodiments of the present disclosure, a brief introduction to the drawings used in describing some embodiments of the present disclosure is provided below. It is evident that the drawings described below are only some of the embodiments of the present disclosure. For those skilled in the art, other drawings may be derived based on the following drawings without creative work.

FIG. 1 is a flowchart of a method for controlling content sharing in some embodiments of the present disclosure.

FIG. 2 is a schematic view illustrating a scenario of a method for controlling content sharing in some embodiments of the present disclosure.

FIG. 3 is a schematic view illustrating another scenario of a method for controlling content sharing in some embodiments of the present disclosure.

FIG. 4 is a schematic view illustrating still another scenario of a method for controlling content sharing in some embodiments of the present disclosure.

FIG. 5 is a schematic view illustrating still another scenario of a method for controlling content sharing in some embodiments of the present disclosure.

FIG. 6 is a schematic view illustrating still another scenario of a method for controlling content sharing in some embodiments of the present disclosure.

FIG. 7 is a schematic view illustrating still another scenario of a method for controlling content sharing in some embodiments of the present disclosure.

FIG. 8 is a structural block diagram of an apparatus for controlling content sharing in some embodiments of the present disclosure.

FIG. 9 is a structural block diagram of a terminal in some embodiments of the present disclosure.

### DETAILED DESCRIPTION

It should be noted that the terms “first”, “second”, “third”, and etc., in the present disclosure are used to distinguish different objects rather than to describe a specific order. Furthermore, the terms “comprise” and “include”, as well as any variations thereof, are intended to encompass non-exclusive inclusion. For example, a process, a method, a system, a product, or a device that includes a series of operations or modules is not limited to the operations or modules explicitly listed but may further include operations or modules not listed, or other operations or modules inherent to the process, the method, the product, or the device in certain embodiments.

References to “embodiment” herein mean that specific features, structures, or characteristics described in connection with an embodiment may be included in at least one embodiment of the present disclosure. The terms “embodiment” appeared in various places in the specification neither are necessarily all referring to the same embodiment, nor are mutually exclusive or alternative embodiments. Those skilled in the art may explicitly and implicitly understand that any embodiment described herein may be combined with other embodiments.

Some embodiments of the present disclosure provide a method for controlling content sharing, an apparatus for controlling content sharing, a storage medium, and a terminal. The method for controlling content sharing may be performed by the apparatus for controlling content sharing provided by some embodiments of the present disclosure, or may be performed by an electronic device in which the apparatus for controlling content sharing is configured or integrated. The apparatus for controlling content sharing may be implemented in form of a hardware or a software. The electronic device may be a mobile terminal, including but not limited to, a smartphone, a tablet, a vehicle-mounted terminal, or a smart wearable device, etc.

Some embodiments of the present disclosure provide a method for controlling content sharing. The method may include the following operations:
displaying a terminal interface, where the terminal interface includes a plurality of display regions;
obtaining first display content displayed in a first display region of the plurality of display regions, in response to a select operation applied on the first display region; and
sharing the first display content to a share receiving terminal.

In some embodiments, the obtaining first display content displayed in a first display region of the plurality of display regions, in response to a select operation applied on the first display region, includes:
displaying a share control widget on a share control page;
determining a display region selected by a drag operation to be the first display region, in response to the drag operation applied on the share control widget; and
obtaining the first display content displayed in the first display region.

In some embodiments, the determining a display region selected by a drag operation to be the first display region, in response to the drag operation applied on the share control widget, includes:
determining, in response to the drag operation applied on the share control widget, the display region selected by the drag operation to be the first display region in a case where the share control widget is dragged to the selected display region of the plurality of display regions and remains in the selected display region for a first stay duration that reaches a preset duration.

In some embodiments, the determining a display region selected by a drag operation to be the first display region, in response to the drag operation applied on the share control widget, includes:
obtaining a drag endpoint position of the drag operation, in response to the drag operation applied on the share control widget; and
determining a display region in which the drag endpoint position is located to be the first display region.

In some embodiments, the method for controlling content sharing may further include the following operations:
displaying a share text prompt in the selected display region in a case where the first stay duration reaches the preset duration, where the share text prompt is configured to prompt locking the content sharing to the selected display region; and
displaying a share control operation instruction, where the share control operation instruction is configured to instruct performing sharing control over the selected display region.

In some embodiments, after the sharing the first display content to a share receiving terminal, the method further includes the following operations:
obtaining a second stay duration for which the share control widget remains in the first display region, in response to another drag operation that drags the share control widget to the first display region again; and
obtaining display content displayed in each of the plurality of display regions and sharing second display content including or consisting of the obtained display content to the share receiving terminal, in a case where the second stay duration reaches the preset duration.

In some embodiments, after the sharing first display content to a share receiving terminal, the method further includes the following operations:
obtaining third display content displayed in a second display region of the plurality of display regions, in response to a drag operation that drags the share control widget to the second display region; and
sharing the third display content to the share receiving terminal.

In some embodiments, before the determining a display region selected by a drag operation to be the first display region, in response to the drag operation applied on the share control widget, the method further includes the following operations:
displaying a default pattern in the share control widget, where the default pattern is configured to indicate that a current screen sharing state is to share all content in a display interface of a screen-share initiating terminal.

In some embodiments, after the sharing the first display content to a share receiving terminal, the method further includes the following operations:
displaying a display icon of a first application corresponding to the first display content in the share control widget.

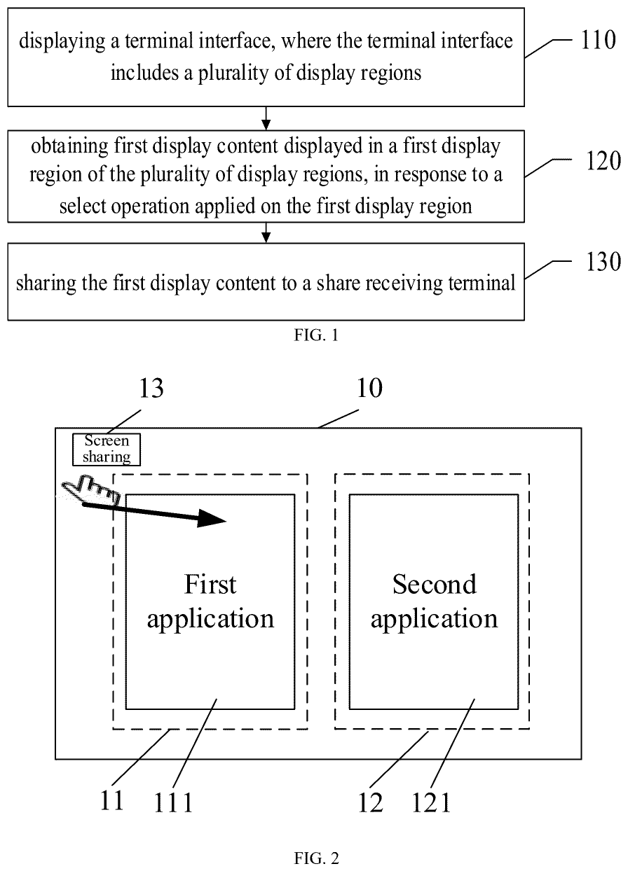

As shown in FIG. 1, FIG. 1 is a flowchart of a method for controlling content sharing in some embodiments of the present disclosure. As shown in FIG. 1, the method for controlling content sharing provided by some embodiments of the present disclosure may include the following operations.

At operation 110, displaying a terminal interface. The terminal interface includes a plurality of display regions.

In some embodiments of the present disclosure, the method for controlling content sharing may be performed by an apparatus for controlling content sharing. The apparatus for controlling content sharing may be configured in a screen-share initiating terminal. The screen-share initiating terminal may include a smartphone, a tablet, a vehicle-mounted terminal, or other smart wearable devices, etc.

In related art, due to a screen size limit of mobile terminals, a display screen of the existing mobile terminal typically displays only one application that is currently running. With the continuous development of mobile terminal technologies, various mobile terminals such as a foldable-screen terminal, a curved-screen terminal, and a wide-screen terminal, etc., have emerged, and split-screen display technologies have been widely adopted. The split-screen display technologies allow or enable a plurality of display regions to be displayed simultaneously on the display screen of the terminal. Each display region may display a menu page or an application page of an application, enabling a user to launch, view, and interact with the application through other operations in each display region individually. The number of the display regions may be two, three, or more, which may be set based on the size of the display screen and user preferences.

As interactions among users of mobile terminals become increasingly frequent and in-depth, information communications based on SMS, phone calls, and instant messaging apps, etc., no longer meet user requirements on information communications. As a result, a screen-sharing application for mobile terminals has been developed. Through the screen-sharing application installed on the mobile terminals, the screen-share initiating terminal may share content displayed on the screen thereof to a screen-share receiving terminal for display, thereby enabling the screen-share initiating terminal to transmit display data to the screen-share receiving terminal in a real-time and visually intuitive manner. In a case where the screen-share initiating terminal displays a plurality of display regions on the screen thereof using the split-screen display technology, the screen-sharing application may share all display content that is displayed in the plurality of display regions of the screen-share initiating terminal in a split-screen manner to the share receiving terminal for display. In other words, the screen sharing function in the related art typically shares all content displayed on the display screen of the screen-share initiating terminal to the share receiving terminal for display. Thus, in some cases, when the user of the share initiating terminal accidentally shares content that is not intended to be shared to the share receiving terminal during screen sharing to the share receiving terminal in the split-screen manner, the content that is not intended to be shared from the share initiating terminal to the share receiving terminal may be leaked, thereby reducing the information security during the content sharing process. Moreover, during the user of the screen-share initiating terminal sharing an application to the screen-share receiving terminal, the screen-share initiating terminal may not be available to use other applications in the split-screen manner (to avoid data leakage), thereby affecting the user experience of the screen-share initiating terminal.

To address the above technical issue of information security being affected due to the terminal leaking data of other applications during the terminal sharing screen while displaying in the split-screen manner, some embodiments of the present disclosure provide a method for controlling content sharing. The method is explained in detail below.

First, a terminal interface may be displayed. The terminal interface may be a share control page of screen sharing. The share control page may include a plurality of display regions. Each display region may display an operation interface of an application or a menu page. The menu page may include application logos of multiple applications. In this case, the screen-share initiating terminal displays in the split-screen manner using the split-screen display technology. In some embodiments of the present disclosure, the share control page for displaying the screen sharing may display in the split-screen manner before the screen sharing starts or after the screen sharing starts. In other words, the content sharing may be controlled first so that the content sharing is locked to a display region before the screen-sharing application is opened. In some embodiments, the screen-sharing application may be opened first to start sharing screen with the share receiving terminal, and the content sharing may then be controlled during the screen sharing process to lock the screen sharing to the display region.

At operation 120, obtaining first display content displayed in a first display region of the plurality of display regions, in response to a select operation applied on the first display region.

In a case where a plurality of display regions are displayed on a display interface of the screen-share initiating terminal, each display region displays corresponding display content. The select operation may then be performed on or 130 applied on the plurality of display regions to lock the screen sharing to a selected display region.

The user of the screen-share initiating terminal may perform the select operation on the display region in the display interface of the screen-share initiating terminal in various ways. In some embodiments, the user of the screen-share initiating terminal may perform the select operation on the plurality of display regions through inputting a voice selection command. In some embodiments, the user of the screen-share initiating terminal may perform the select operation on the plurality of display regions through clicking on a display region. In some embodiments, the user of the screen-share initiating terminal may perform the select operation on the plurality of display regions through dragging a share control widget to a display region. To distinguish the selected display region from any other display region, the selected display region may be referred to as a first display region.

In some embodiments, the obtaining first display content displayed in a first display region of the plurality of display regions, in response to a select operation applied on the first display region may include the following operations:
1, displaying a share control widget on a share control page;
2, determining a display region selected by a drag operation to be the first display region, in response to the drag operation applied on the share control widget; and
3, obtaining the first display content displayed in the first display region.

In some embodiments of the present disclosure, a selection from the plurality of display regions that are displayed in the split-screen manner on the screen-share initiating terminal during the screen sharing process may be performed by the drag operation performed on or applied on the share control widget displayed on the share control page. In some embodiments, when the screen-share initiating terminal is in the screen sharing process, the share control page may display, in addition to the plurality of display regions, the share control widget. Then, in response to the drag operation applied on the share control widget, the display region selected by the drag operation is determined to be the first display region.

As shown in FIG. 2, FIG. 2 is a schematic view illustrating a scenario of a method for controlling content sharing in some embodiments of the present disclosure. As shown in FIG. 2, a share control page 10 is displayed on the display screen of the screen-share initiating terminal. The share control page 10 includes two display regions, that is, a first display region 11 and a second display region 12. The share control page 10 further includes a share control widget 13. The first display region 11 displays a first operation interface 111 corresponding to a first application. The second display region 12 displays a second operation interface 121 corresponding to a second application. That is, the screen-share initiating terminal displays both the first application and the second application in the split-screen manner. In this case, when the screen-share initiating terminal opens the screen-sharing application, display content of both the first application and the second application is entirely shared to the screen-share receiving terminal for shared display. During the screen sharing process, the display screen of the screen-share initiating terminal displays the share control page 10. The share control page 10 includes the first display region 11, the second display region 12, and the share control widget 13 mentioned above. Since the current screen sharing shares all display content of the screen-share initiating terminal to the screen-share receiving terminal, the share control widget 13 displays a default pattern of the screen-sharing application. The user may determine, based on the pattern, that a current screen sharing state is to share all content in the display interface of the screen-share initiating terminal. On the share control page 10, the user may select to share an application through dragging the share control widget 13. For instance, the user may drag the share control widget 13 to the first display region 11 to select the first display region 11 as a region where the screen sharing needs to be locked to. After the share control widget 13 is dragged to the first display region 11, a range of the screen sharing is locked within the first display region 11. In this way, the display content of the first display region 11 (referred to as the first display content herein) may be obtained and shared to the share receiving terminal. That is, the share receiving terminal may only display the first display content mentioned above.

In some embodiments, the determining a display region selected by a drag operation to be the first display region, in response to the drag operation applied on the share control widget may include the following operation:

in response to the drag operation applied on the share control widget, determining the display region selected by the drag operation to be the first display region in a case where the share control widget is dragged to any selected display region of the plurality of display regions and remains in the selected display region for a first stay duration that reaches a preset duration.

In some embodiments of the present disclosure, dragging the share control widget may include first clicking or touching a display location of the share control widget on the screen of the screen-share initiating terminal and then performing the drag operation on the screen of the screen-share initiating terminal while maintaining the touching. During the dragging process, the user's finger remains touching or in contact with the screen-share initiating terminal and position information of a dragging touch point is obtained in real-time. During a process of obtaining the position information of the dragging touch point in real-time, whether the dragging touch point is located in a display region may be further detected based on the position information of the dragging touch point obtained in real-time. When the dragging touch point is detected to be located in a target display region, a duration for which the dragging touch point remains in the target display region may be further obtained, which is referred to as the first stay duration herein for the purpose of being distinguished from any other stay duration. The selected target display region is determined to be the aforementioned first display region in a case where the first stay duration reaches the preset duration. In some embodiments of the present disclosure, the purpose of obtaining the duration for which the dragging touch point remains in the target display region and determining whether the duration reaches the preset duration is to reduce a misoperation where a region is incorrectly determined to be the first display region as a result of the dragging touch point passing through the display region during the dragging process. Since a screen of a device may display a plurality of display regions in the split-screen manner, when a connection line between an initial position of the share control widget and the first display region to be selected passes through any other display region, a shortest dragging path from the initial position of the share control widget to the first display region may pass through other display regions. In this case, a minimum duration for the dragging touch point to remain in the display region may be set to reduce a problem of misidentification, thereby further improving an accuracy in controlling the content sharing.

In some embodiments, the method for controlling content sharing provided by some embodiments of the present disclosure further includes the following operations:
a, displaying a share text prompt in the selected display region, in a case where the first stay duration reaches the preset duration, where the share text prompt is configured to prompt locking the content sharing to the selected display region; and
b, displaying a share control operation instruction, where the share control operation instruction is configured to instruct performing sharing control over the selected display region.

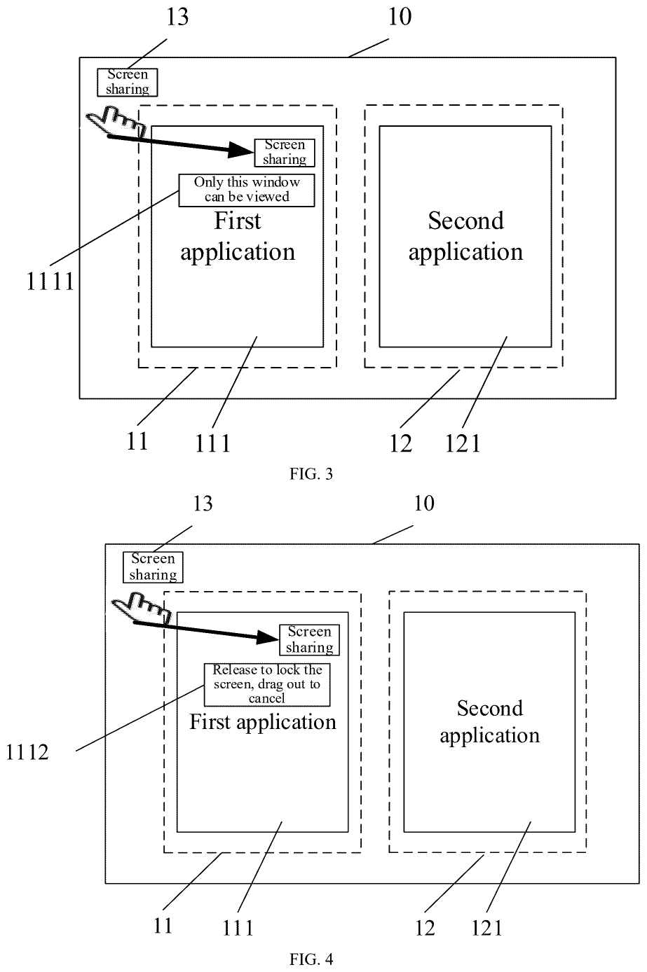

In some embodiments of the present disclosure, in a case where the user of the screen-share initiating terminal drags the share control widget to a selected display region and a duration for which the share control widget remains in the selected display region reaches the preset duration, the share text prompt may be displayed in the selected display region. The share text prompt is configured to prompt that a current operation applied on the screen-share initiating terminal may lock the screen sharing to share content in the currently selected display region. In some embodiments, the share text prompt may be “Only this window can be viewed.” As shown in FIG. 3, FIG. 3 is a schematic view illustrating another scenario of a method for controlling content sharing in some embodiments of the present disclosure. In a case where the user of the screen-share initiating terminal drags the share control widget to the first display region 11 and the duration for which the dragging touch point remains in the first display region 11 reaches the preset duration, a share prompt label 1111 may be triggered to display. The share text prompt “Only this window can be viewed” is displayed in the share prompt label 1111.

Moreover, a share control operation instruction may further be displayed in the selected display region. The share control operation instruction may be configured to instruct an operation on how to perform sharing control over the selected display region. For example, the share control operation instruction may be “Release to lock the screen, drag out to cancel.” As shown in FIG. 4, FIG. 4 is a schematic view illustrating still another scenario of a method for controlling content sharing in some embodiments of the present disclosure. As shown in FIG. 4, when the share prompt label 1111 has been displayed in the first display region 11 for a preset duration, e.g., 1 second, the first display region 11 may switch to display a control operation instruction label 1112. In some embodiments of the present disclosure, an operation prompt and an operation instruction are displayed at appropriate moments during the content sharing control process to provide the user operation instructions, thereby facilitating the user to better understand their operation actions and operation results and enhancing the content sharing control experience of the user.

In some embodiments, the determining a display region selected by a drag operation to be the first display region, in response to the drag operation applied on the share control widget may include the following operations:
A, obtaining a drag endpoint position of the drag operation, in response to the drag operation applied on the share control widget; and
B, determining a display region in which the drag endpoint position is located to be the first display region.

In some embodiments of the present disclosure, the display region selected by the drag operation may be determined based on the drag endpoint position corresponding to the drag operation applied on or performed on the share control widget. The drag endpoint position refers to an ending position of the drag operation, i.e., a position of the share control widget where the user releases the finger from the screen of the screen-share initiating terminal during the process of dragging the share control widget. In other words, the drag endpoint position may be understood as a position of the share control widget where the share control widget is released. In some embodiments, in response to the drag operation applied on or performed on the share control widget, the drag endpoint position of the drag operation may be obtained. Then, whether the drag endpoint position is located in a display region may be determined based on the drag endpoint position. When the drag endpoint position is located in a display region, the display region is determined to be the first display region.

It should be understood that after the user releases the share control widget, the share control widget may return to the initial position of the share control widget. As shown in FIG. 5, FIG. 5 is a schematic view illustrating still another scenario of a method for controlling content sharing in some embodiments of the present disclosure. As shown in FIG. 5, after the user of the screen-share initiating terminal drags the share control widget 13 to the first display region 11 and then releases the share control widget 13, the apparatus for controlling content sharing may automatically lock the screen sharing to share content in the first display region 11. After the user releases the share control widget 13, the share control widget 13 may automatically return to the initial position of the share control widget 13, and the pattern displayed in the share control widget 13 switches from the default pattern of the screen-sharing application to a display icon corresponding to the first application displayed in the first display region 11. In this way, the user of the screen-share initiating terminal may get to know information regarding the application that the screen sharing is currently locked to share based on the icon displayed in the share control widget 13.

At operation 130, sharing the first display content to a share receiving terminal.

After the first display region corresponding to the select operation is determined, the first display content of the first display region may be further obtained and shared to the share receiving terminal. In other words, based on the select operation applied on or performed on any display region of the plurality of display regions displayed on the share control page, the shared content of the screen sharing switches from all content on the display screen of the screen-share initiating terminal to only display content in the selected display region. In this way, the user of the screen-share initiating terminal is enabled or allowed to view information of another application through the split-screen manner when sharing screen to the screen-share receiving terminal, while the information of the another application will not be shared to the screen-share receiving terminal when the user is viewing the information of the another application, thereby ensuring the information security during the screen sharing process while maintaining the split-screen experience.

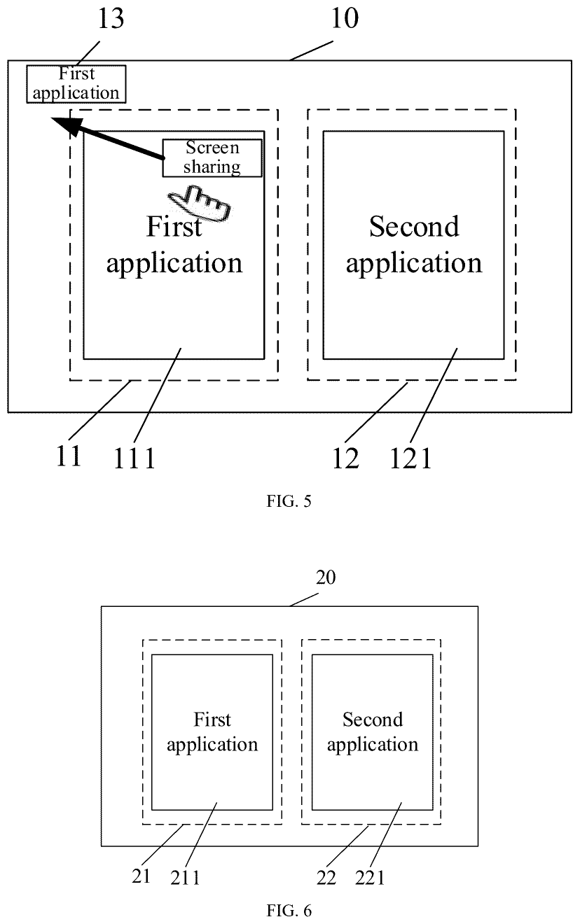

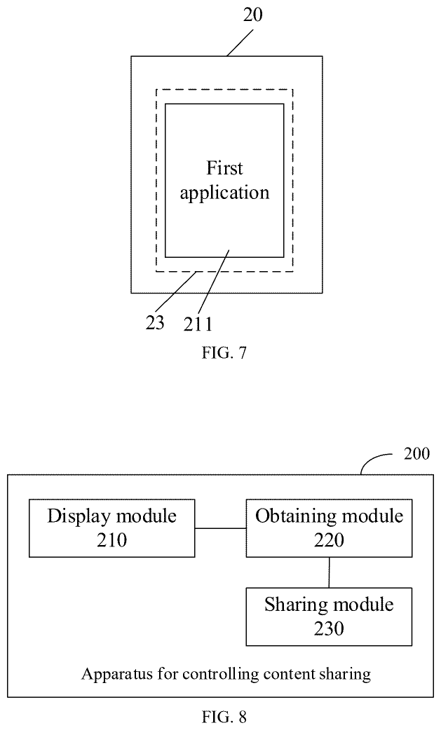

In some embodiments, as shown in FIGS. 6 and 7, still other scenarios of methods for controlling content sharing in some embodiments of the present disclosure are provided. FIG. 6 shows a display state of the share receiving terminal before the screen sharing is locked to share the first application. FIG. 7 shows a display state of the share receiving terminal after the screen sharing is locked to share the first application. In some embodiments, as shown in FIG. 6, a display page 20 of the screen-share receiving terminal displays a third display region 21 and a fourth display region 22. The third display region 21 displays a third operation interface 211 corresponding to the first application. The fourth display region 22 displays a fourth operation interface 221 of the second application. It can be understood that the third display region 21 corresponds to the first display region 11 displayed on the share initiating terminal, and the fourth display region 22 corresponds to the second display region 12 displayed on the share initiating terminal. The third operation interface 211 corresponds to the first operation interface 111 displayed on the screen-share initiating terminal. The fourth operation interface 221 corresponds to the second operation interface 121 displayed on the screen-share initiating terminal. In other words, before the screen sharing is locked to share the first application, an operation interface of each application displayed on the screen-share initiating terminal is shared to the screen-share receiving terminal for display. As shown in FIG. 7, the display page 20 of the screen-share receiving terminal displays a fifth display region 23. The fifth display region 23 displays the third operation interface 211. That is, after the screen sharing is locked to the first display region 11, the screen-share receiving terminal may only display the display content corresponding to the first display region 11 and the display content corresponding to the second display region 12 may no longer be displayed.

In some embodiments, after the sharing the first display content to a share receiving terminal, the method may further include the following operations:
1, obtaining a second stay duration for which the share control widget remains in the first display region, in response to another drag operation that drags the share control widget to the first display region again; and
2, obtaining display content displayed in each display region and sharing second display content including or consisting of the obtained display content of each display region to the share receiving terminal, in a case where the second stay duration reaches the preset duration.

In some embodiments of the present disclosure, the user of the screen-share initiating terminal may unlock the screen sharing of an application through dragging the share control widget to the first display region again and remaining the share control widget in the first display region for a certain duration. In some embodiments, in a case where the screen sharing is performing with the screen sharing locked to the first display region, in response to another drag operation that drags the share control widget to the first display region again, the second stay duration for which the share control widget remains in the first display region may be obtained. In a case where the second stay duration reaches the preset duration, the display content of each display region displayed in the screen-share initiating terminal may be obtained. The second display content including or consisting of the obtained display content of the display content of each display region (i.e., all content displayed on the display interface of the screen-share initiating terminal) is shared to the share receiving terminal.

After the screen sharing of the display region is unlocked, the share control widget may bounce back to the initial position of the share control widget, and the pattern displayed on the share control widget may switch back to the default icon of the screen-sharing application again.

In some embodiments, after the sharing the first display content to a share receiving terminal, the method further includes the following operations:
A, obtaining third display content displayed in a second display region of the plurality of display regions, in response to a drag operation that drags the share control widget to the second display region; and
B, sharing the third display content to the share receiving terminal.

In some embodiments of the present disclosure, after the screen sharing is locked to the first display region, the display region where the screen sharing is locked may be switched to another display region through dragging the share control widget to the another display region. In some embodiments, in response to the drag operation that drags the share control widget to the second display region, the third display content displayed in the second display region may be obtained. Then, the third display content may be shared to the share receiving terminal.

Furthermore, the share control widget may automatically bounce back to the initial position of the share control widget and the pattern displayed in the share control widget may switch to a pattern associated with the application displayed in the second display region, thereby enabling the user to clearly understand that the screen sharing is currently locked to share the application corresponding to the second display region.

Based on the above description, the method for controlling content sharing provided by some embodiments of the present disclosure includes the following operations: displaying a terminal interface that includes a plurality of display regions; obtaining first display content displayed in a first display region of the plurality of display regions, in response to a select operation applied on the first display region; and sharing the first display content to a share receiving terminal. In this way, the selection from the plurality of display regions that are displayed in the split-screen manner may be performed during the screen sharing process to lock the screen sharing to share the content in the selected display region, thereby ensuring the split-screen experience of the user of the screen-share initiating terminal while maintaining the information security during the screen sharing process.

As shown in FIG. 8, FIG. 8 is a structural block diagram of an apparatus 200 for controlling content sharing in some embodiments of the present disclosure. The apparatus 200 for controlling content sharing may be configured in an electronic device provided by some embodiments of the present disclosure. As shown in FIG. 8, the apparatus 200 for controlling content sharing may include the following modules.

A display module 210 may be configured to display a terminal interface. The terminal interface includes a plurality of display regions.

An obtaining module 220 may be configured to obtain first display content displayed in a first display region of the plurality of display regions, in response to a select operation applied on the first display region.

A sharing module 230 may be configured to share the first display content to a share receiving terminal.

In some embodiments, the obtaining module 220 may include the following modules.

A first display sub-module may be configured to display a share control widget on a share control page.

A determination sub-module may be configured to determine a display region selected by a drag operation to be the first display region, in response to the drag operation applied on the share control widget.

A first obtaining sub-module may be configured to obtain the first display content displayed in the first display region.

In some embodiments, the determination sub-module may be further configured to, in response to the drag operation applied on the share control widget, determine the display region selected by the drag operation to be the first display region, in a case where the share control widget is dragged to any selected display region of the plurality of display regions and remains in the selected display region for a first stay duration that reaches a preset duration.

In some embodiments, the determination sub-module may include the following units.

An obtaining unit may be configured to obtain a drag endpoint position of the drag operation, in response to the drag operation applied on the share control widget.

A determination unit may be configured to determine a display region in which the drag endpoint position is located to be the first display region.

In some embodiments, the apparatus 200 for controlling content sharing may further include the following modules.

A second display sub-module may be configured to display a share text prompt in the selected display region, in a case where the first stay duration reaches the preset duration. The share text prompt is configured to prompt locking the content sharing to the selected display region.

A third display sub-module may be configured to display a share control operation instruction. The share control operation instruction is configured to instruct performing sharing control over the selected display region.

In some embodiments, the apparatus 200 for controlling content sharing may further include the following modules.

A second obtaining sub-module may be configured to obtain a second stay duration for which the share control widget remains in the first display region, in response to another drag operation that drags the share control widget to the first display region again.

A first sharing sub-module may be configured to obtain display content displayed in each display region and share second display content including or consisting of the obtained display content of each display region to the share receiving terminal, in a case where the second stay duration reaches the preset duration.

In some embodiments, the apparatus 200 for controlling content sharing may further include the following modules.

A third obtaining sub-module may be configured to obtain third display content displayed in a second display region of the plurality of display regions, in response to a drag operation that drags the share control widget to the second display region.

A second sharing sub-module may be configured to share the third display content to the share receiving terminal.

It should be noted that, the apparatus 200 for controlling content sharing provided by some embodiments of the present disclosure shares the same concept with the method for controlling content sharing shown in FIG. 1 according to some embodiments above. A detailed implementation process of the apparatus 200 for controlling content sharing may refer to the relevant embodiments above, which will not be repeated herein.

According to the above description, the apparatus 200 for controlling content sharing provided by some embodiments of the present disclosure includes the following modules. The display module 210 may be configured to display a terminal interface. The terminal interface includes a plurality of display regions. The obtaining module 220 may be configured to obtain first display content displayed in a first display region of the plurality of display regions, in response to a select operation applied on the first display region. The sharing module 230 may be configured to share the first display content to a share receiving terminal. In this way, the selection from the plurality of display regions that are displayed in the split-screen manner may be performed during the screen sharing process to lock the screen sharing to share the content in the selected display region, thereby ensuring the split-screen experience of the user of screen-share initiating terminal while maintaining the information security during the screen sharing process.

Some embodiments of the present disclosure further provide a storage medium. The storage medium may store a computer program which, when executed by a processor of the electronic device provided by some embodiments of the present disclosure, causes the processor of the electronic device to perform an operation in any method above for controlling content sharing that is applicable to the electronic device. The storage medium may include a magnetic disk, an optical disk, a read-only memory (ROM), or a random access memory (RAM), etc.

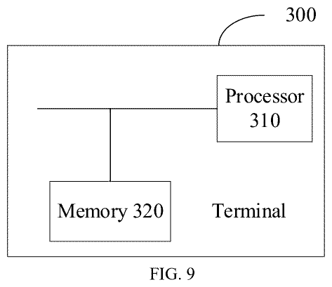

Some embodiments of the present disclosure provide a terminal. As shown in FIG. 9, the terminal 300 includes a processor 310 and a memory 320.

The processor 310 in some embodiments of the present disclosure may be a general-purpose processor, such as a processor based on an acorn RISC machine (ARM) architecture. The memory 320 stores a computer program. The memory 320 may be a high-speed RAM or a non-volatile memory. For example, the memory 320 may include at least one of the following: a disk storage device, a flash memory device, or any other volatile solid-state storage device, etc. Correspondingly, the memory 320 may further include a memory controller to provide the processor 310 with an access to the memory 320. When the computer program stored in the memory 320 is executed by the processor 310, the processor 310 is caused to perform any one of the above methods for controlling content sharing. For example, the method may include:
displaying a terminal interface, where the terminal interface includes a plurality of display regions;
obtaining first display content displayed in a first display region of the plurality of display regions, in response to a select operation applied on the first display region; and
sharing the first display content to a share receiving terminal.

The above describes the method for controlling content sharing, the apparatus for controlling content sharing, the storage medium, and the terminal provided by some embodiments of the present disclosure in detail. Specific examples are used herein to explain principles and implementation methods of some embodiments of the present disclosure. The descriptions of the above embodiments are merely intended to help understand the methods and core concepts of the present disclosure. In addition, those skilled in the art may change specific embodiments and the scope of application based on the concepts of the present disclosure. Therefore, the content of this specification should not be construed as limiting the present disclosure.

What is claimed is:

1. A method for controlling content sharing, comprising:
displaying a terminal interface, wherein the terminal interface comprises a plurality of display regions;
obtaining first display content displayed in a first display region of the plurality of display regions, in response to a select operation applied on the first display region; and
sharing the first display content to a share receiving terminal.

2. The method as claimed in claim 1, wherein the obtaining first display content displayed in a first display region of the plurality of display regions, in response to a select operation applied on the first display region, comprises:
displaying a share control widget on a share control page;
determining a display region selected by a drag operation to be the first display region, in response to the drag operation applied on the share control widget; and
obtaining the first display content displayed in the first display region.

3. The method as claimed in claim 2, wherein the determining a display region selected by a drag operation to be the first display region, in response to the drag operation applied on the share control widget, comprises:
determining, in response to the drag operation applied on the share control widget, the display region selected by the drag operation to be the first display region in a case where the share control widget is dragged to the selected display region of the plurality of display regions and remains in the selected display region for a first stay duration that reaches a preset duration.

4. The method as claimed in claim 2, wherein the determining a display region selected by a drag operation to be the first display region, in response to the drag operation applied on the share control widget, comprises:
obtaining a drag endpoint position of the drag operation, in response to the drag operation applied on the share control widget; and
determining a display region in which the drag endpoint position is located to be the first display region.

5. The method as claimed in claim 3, further comprising:
displaying a share text prompt in the selected display region in a case where the first stay duration reaches the preset duration, wherein the share text prompt is configured to prompt locking the content sharing to the selected display region; and
displaying a share control operation instruction, wherein the share control operation instruction is configured to instruct performing sharing control over the selected display region.

6. The method as claimed in claim 3, wherein after the sharing the first display content to a share receiving terminal, the method further comprises:
obtaining a second stay duration for which the share control widget remains in the first display region, in response to another drag operation that drags the share control widget to the first display region again; and
obtaining display content displayed in each of the plurality of display regions and sharing second display content comprising the obtained display content to the share receiving terminal, in a case where the second stay duration reaches the preset duration.

7. The method as claimed in claim 2, wherein after the sharing first display content to a share receiving terminal, the method further comprises:
obtaining third display content displayed in a second display region of the plurality of display regions, in response to a drag operation that drags the share control widget to the second display region; and
sharing the third display content to the share receiving terminal.

8. The method as claimed in claim 2, wherein before the determining a display region selected by a drag operation to be the first display region, in response to the drag operation applied on the share control widget, the method further comprises:
displaying a default pattern in the share control widget, wherein the default pattern is configured to indicate that a current screen sharing state is to share all content in a display interface of a screen-share initiating terminal.

9. The method as claimed in claim 2, wherein after the sharing the first display content to a share receiving terminal, the method further comprises:
displaying a display icon of a first application corresponding to the first display content in the share control widget.

10. A non-transitory computer-readable storage medium, storing a computer program which, when executed by a processor of an electronic device, causes the processor to perform the following operations:
displaying a terminal interface, wherein the terminal interface comprises a plurality of display regions;
obtaining first display content displayed in a first display region of the plurality of display regions, in response to a select operation applied on the first display region; and
sharing the first display content to a share receiving terminal.

11. The non-transitory computer-readable storage medium as claimed in claim 10, wherein in performing the operation of obtaining first display content displayed in a first display region of the plurality of display regions, in response to a select operation applied on the first display region, the processor is configured to perform:
displaying a share control widget on a share control page;
determining a display region selected by a drag operation to be the first display region, in response to the drag operation applied on the share control widget; and
obtaining the first display content displayed in the first display region.

12. A terminal, comprising a processor and a memory, wherein the memory stores a computer program which, when executed by the processor, causes the processor to perform the following operations:
displaying a terminal interface, wherein the terminal interface comprises a plurality of display regions;
obtaining first display content displayed in a first display region of the plurality of display regions, in response to a select operation applied on the first display region; and
sharing the first display content to a share receiving terminal.

13. The terminal as claimed in claim 12, wherein in performing the operation of obtaining first display content displayed in a first display region of the plurality of display regions, in response to a select operation applied on the first display region, the processor is configured to perform:
displaying a share control widget on a share control page;
determining a display region selected by a drag operation to be the first display region, in response to the drag operation applied on the share control widget; and
obtaining the first display content displayed in the first display region.

14. The terminal as claimed in claim 13, wherein in performing the operation of determining a display region selected by a drag operation to be the first display region, in response to the drag operation applied on the share control widget, the processor is configured to perform:
determining, in response to the drag operation applied on the share control widget, the display region selected by the drag operation to be the first display region in a case where the share control widget is dragged to the selected display region of the plurality of display regions and remains in the selected display region for a first stay duration that reaches a preset duration.

15. The terminal as claimed in claim 13, wherein in performing the operation of determining a display region selected by a drag operation to be the first display region, in response to the drag operation applied on the share control widget, the processor is configured to perform:
obtaining a drag endpoint position of the drag operation, in response to the drag operation applied on the share control widget; and
determining a display region in which the drag endpoint position is located to be the first display region.

16. The terminal as claimed in claim 14, wherein the processor is further configured to perform:
displaying a share text prompt in the selected display region in a case where the first stay duration reaches the preset duration, wherein the share text prompt is configured to prompt locking the content sharing to the selected display region; and
displaying a share control operation instruction, wherein the share control operation instruction is configured to instruct performing sharing control over the selected display region.

17. The terminal as claimed in claim 14, wherein after the sharing the first display content to a share receiving terminal, the processor is further configured to perform:
obtaining a second stay duration for which the share control widget remains in the first display region, in response to another drag operation that drags the share control widget to the first display region again; and
obtaining display content displayed in each of the plurality of display regions and sharing second display content comprising the obtained display content to the share receiving terminal, in a case where the second stay duration reaches the preset duration.

18. The terminal as claimed in claim 13, wherein after the sharing first display content to a share receiving terminal, the processor is further configured to perform:
obtaining third display content displayed in a second display region of the plurality of display regions, in response to a drag operation that drags the share control widget to the second display region; and
sharing the third display content to the share receiving terminal.

19. The terminal as claimed in claim 13, wherein before the determining a display region selected by a drag operation to be the first display region, in response to the drag operation applied on the share control widget, the processor is further configured to perform:
displaying a default pattern in the share control widget, wherein the default pattern is configured to indicate that a current screen sharing state is to share all content in a display interface of a screen-share initiating terminal.

20. The terminal as claimed in claim 13, wherein after the sharing the first display content to a share receiving terminal, the processor is further configured to perform:
displaying a display icon of a first application corresponding to the first display content in the share control widget.
